(19) United States
(12) Patent Application Publication
(10) Pub. No.: US 2019/0078530 A1
(43) Pub. Date: Mar. 14, 2019

(54) INTERNAL COMBUSTION ENGINE

(71) Applicant: GE Jenbacher GmbH & Co. OG, Jenbach (AT)

(72) Inventors: Raphael BURGMAIR, Feldkirchen-Westerham (DE); Dino IMHOF, Baden (CH); Satria MEDY, Munchen (DE)

(21) Appl. No.: 16/064,535

(22) PCT Filed: Nov. 3, 2016
(86) PCT No.: PCT/AT2016/060101

§ 371 Date: Nov. 13, 2018

(30) Foreign Application Priority Data
Nov. 4, 2015 (EP) 15192916.3

(51) Int. Cl. F02D 41/40; F02D 19/06; F02D 19/10; F02D 29/00; F02D 41/00; F02D 41/14; F02D 41/24; F02D 41/30; F02M 43/04

(52) U.S. Cl. CPC F02D 41/40; F02D 19/061; F02D 19/0631; F02D 19/105; F02D 29/00; F02D 41/0027; F02D 2041/286; F02D 41/247; F02D 41/3047; F02M 43/04; F02D 2041/1416; F02D 2041/143; F02D 2041/1434; F02D 41/1402

(57) ABSTRACT

A Dual-fuel combustion engine, possessing:
a control device
at least one combustion chamber
at least one gas supply device for supplying a gaseous fuel to at least one combustion chamber, and
at least one injector for injecting liquid fuel into the at least one combustion chamber, and which injector is controllable through a control device by the use of an actuator triggering signal, for which at least one injector possesses an output opening for the liquid fuel, which is closable by means of a needle (6), and for which the control device regulates through the use of the actuator triggering signal, the opening of the needle (6) in the ballistic region of the needle in a pilot operating mode of the combustion engine
   to which end, an algorithm is stored in the control device, which receives, as input values, at least the actuator triggering signal (Δt) and, using an injector model, calculates the mass of liquid fuel introduced via the output opening of the injector, and which compares the mass calculated by means of the injector model with a required target value (m_{d}^{ref}) of the mass of liquid fuel, and on the basis of the result of such comparison, either leaves the actuator triggering signal (Δt) unchanged or corrects it, and a process for the operation of a combustion engine and of an injector.

This invention concerns a dual-fuel combustion engine having the characteristics of the generic concept in Claim 1 and a process with the characteristics of the generic concept in Claim 12 or 13.

Dual-fuel combustion engines are typically operated in two operating modes. A distinction is made between an operating mode using a primarily liquid fuel supply (briefly known as “fluid operation”; in the case when diesel is used as a liquid fuel, also called “diesel operation”) and an operating mode using fuel supplied primarily in gas form, and in this mode the liquid fuel serves as a pilot fuel for initiating combustion (“Gas operation”, or also called “pilot operation” or “ignition jet operation”). Diesel may be mentioned as an example of the liquid fuel. It could also be heavy fuel oil or some other fuel capable of self-ignition. Natural gas may be mentioned as an example for the gaseous fuel. Other gaseous fuels such as biogas etc. are also possible.

During pilot operation, a small quantity of liquid fuel is introduced into a piston cylinder unit as a so-called pilot injection. Because of the conditions existing at the time of injection, the liquid fuel that has been introduced ignites the mixture of gaseous fuel and air present in a combustion chamber of the piston cylinder unit. The quantity of liquid fuel in a pilot injection is typically 0.5-5% of the total quantity of energy applied to the piston cylinder unit in one working cycle of the combustion engine.

For the clarification of terms, it is defined that the combustion engine is operated either in pilot operation or in diesel operation. With regard to the control device, pilot operation of the combustion engine is described as pilot mode, a liquid operation of the combustion engine with regard to the control device is described as the liquid mode. In addition, there is also a mixed operation.

A ballistic region is understood to be an operation of the fuel injector, during which the injection needle, starting from a “fully closed” position, moves towards a “fully open” position, but without reaching it. Consequently, the injection needle moves back towards the “fully closed” position without having reached the “fully open” position.

The substitution rate indicates what proportion of the energy introduced into the combustion engine is provided in the form of a gaseous fuel. It is attempted to achieve substitution rates between 98 and 99.5%. Such high substitution rates require a design for the combustion engine, for example, with respect to the compression ratio, similar to that for a gas engine. The sometimes contradictory demands made of the combustion engine for pilot operation and liquid operation lead to compromises in design, for example, with respect to the compression ratio.

In the current state of the art, it is problematic that over the lifetime of an injector, it is not possible to carry out an exact regulation of the injected quantity of liquid fuel for very small quantities (high substitution rates) when using a single injector with only a single needle since the latter is in the ballistic region when very small quantities are used. Due to statistical fluctuations, variability in manufacture, wear etc., the activation of the actuator opening the needle does not correspond precisely to the mass of liquid fuel injected.

Instead of using an injector with only one needle, which can be operated both in the pilot operation and in an operating mode with an increased proportion of liquid fuel, use is therefore made either of two separate injectors or of one injector with two separate needles. It is also known that the substitution rate may be subjected to an upper limit.

WO 2014/202202 A1 describes an injector for a combustion engine typical of its class in which, by means of which the pressure drop in an accumulator chamber is measured, using a pressure sensor arranged in the injector, and this is used to determine the actual injection period. However, for very small quantities, the pressure drop is too small to give a sufficiently accurate correlation with the duration of the injection.

The object of the invention is to provide a dual-fuel combustion engine and a process in which a precise control of the injected quantity of liquid fuel is possible, even for very small quantities.

This task is achieved through a dual-fuel combustion engine with the characteristics of Claim 1 and a process with the characteristics of Claim 12 or 13. Advantageous embodiments of the invention are defined in the dependent claims.

Because an algorithm is contained in the control device, which receives as input values at least the actuator triggering signal and calculates the mass of the liquid fuel introduced from the output opening of the injector, using an injector model, and then compares the mass calculated using the injector model with a required target value for the mass of liquid fuel, and either retains or corrects the actuator triggering signal, depending on the result of the comparison, it is possible to precisely control even very small quantities of liquid fuel by using only a single injector with only a single needle, in which case, the substitution rate does not need to be subject to an upper limit. One single injector with only one needle can be operated within the range from 0% substitution rate to a selected upper limited (e.g. 99.5%) for the substitution rate. It is therefore possible with the same injector, to operate in liquid mode, pilot mode, or in mixed operation.

The algorithm estimates a mass of injected liquid fuel on the basis of the actuator triggering signal. The invention then starts with the mass of injected fuel calculated by the algorithm and compares this value with the required target value. In the event of differences, correction can be made immediately (e.g. within 10 milliseconds).

Of course, instead of the mass of injected fuel, the volume or other values could be calculated, which are characteristic of a particular mass of injected liquid fuel. All these possibilities are covered by the use of the term “mass” in the present disclosure.

Preferably, at least one sensor is provided, through which at least one measurement value of the at least one injector can be measured, for which purpose the sensor is, or can be brought into signal connection with the control device. In this case, the algorithm can calculate the mass of liquid fuel introduced from the output opening of the injector by use of the injector model, taking into account the at least one measurement value. Of course, it is also possible to use a number of measurement values for estimating the mass of liquid fuel introduced.

It is preferably provided that the algorithm includes a preliminary control value which, using the required target value for the mass of liquid fuel, calculates a preliminary control command (also called “preliminary control signal”) for the actuator control signal for the injection period. The preliminary control ensures a rapid system response since it activates the injector with a particular injection duration, as if no injector variability existed. The preliminary control value uses e.g. one field of injector characteristics (which, for example, indicates the duration of current supply for an actuator designed as a solenoid valve using the injection mass or volume) or an inverted injector model in order to convert the target value for the mass of liquid fuel to be injected, into the preliminary control command for the injection duration.

In one embodiment of a control device with a preliminary control system, it can preferably be provided that the algorithm has a feedback loop, which calculates, by means of the injector model, the mass of liquid fuel injected through the output opening of the injector which, taking into consideration the preliminary control command for the injection duration and the at least one measure, if required (in the event of a difference), corrects the target value which has been calculated for the injector duration, using the preliminary control. The feedback loop is used in order to correct inaccuracies in the preliminary control value (due to manufacturing variabilities, wear, etc.).

It is preferable that the algorithm possesses an observer function, which, using the injector model, estimates the injected mass of liquid fuel depending on at least one measured value and at least one actuator control signal . An actual measurement of the injected mass of liquid fuel is therefore not required for the feedback loop. Irrespective of whether a feedback loop is provided, the injected mass of liquid fuel estimated by the observer can be used in the preliminary control in order to improve the actuator control signal.

From the literature, various possible designs for the observer are known to professionals (e.g. Luenberger-Observer, Kalman-Filter, “Sliding Mode” observer, etc.).

With the help of the injector model, the observer may also serve to take into account the changing condition of the injector (e.g.

through aging or wear) in order to improve the preliminary control signal and/or the actuator triggering signal.

Basically, it is possible to calculate the actuator triggering signal directly based on the target value for the injected mass of liquid fuel and based on the mass of liquid fuel estimated by the observer. In this way, an adaptive preliminary control signal is obtained that is modified by the observer. In this case, the control system is not designed in two parts, with a preliminary control and a feedback loop to correct the preliminary control signal.

It can be stipulated that the injector model includes at least:
the progressions of the pressure in the volumes of the injector that are filled with liquid fuel
the mass flow rates between the injector volumes that are filled with liquid fuel
one position of the needle, preferably relative to the needle seat
the dynamics of the needle actuator, preferably the dynamics of a solenoid valve

The injector may possess as a minimum:
one input accumulator chamber connected with one Common-Rail of the combustion engine
one accumulator chamber for liquid fuel that is connected to the input accumulator chamber
one volume above the needle seat that is connected with the accumulator chamber
one connection volume that is connected on the one side with the accumulator chamber and on the other side with an outflow duct
one introduction opening for liquid fuel that can be closed by means of a needle, and which is connected with the volume above the needle seat
one actuator, preferably a solenoid valve, that can be triggered by means of an actuator triggering signal, for opening the needle
preferably one control chamber joined on the one side to the accumulator chamber and on the other side to the connection volume

The needle is usually pretensioned by a spring in the direction opposite to the opening direction.

An injector may also be provided, which succeeds in functioning without a control chamber, e.g. an injector in which the needle is triggered by a Piezo element.

The at least one measurement value can be selected e.g. from the following values or from a combination of them:
pressure in one Common-Rail of the combustion engine
pressure in one input accumulator chamber of the injector
pressure in one control chamber of the injector
commencement of the lift-off of the needle from the needle seat

The control device can, in addition, be so designed that it implements the algorithm during each combustion cycle or during selected combustion cycles of the combustion engine, and in the event of deviations, that it corrects the actuator triggering signal during that combustion cycle.

Alternatively, the control device can be so designed that it implements the algorithm during each combustion cycle or selected combustion cycles of the combustion engine, and in the event of deviations, corrects the actuator triggering signal in one of the subsequent combustion cycles, preferably the immediately subsequent combustion cycle.

Alternatively, or in addition to one of the above embodiments, the control device can be so designed as to implement the algorithm during each combustion cycle or during selected combustion cycles of the combustion engine and statically to evaluate any deviations that have occurred and to carry out a correction for this or one of the subsequent combustion cycles depending on such static evaluation.

It is not absolutely necessary for the invention that the mass of injected liquid fuel should be directly measured. It is also not necessary to derive the actually injected mass of liquid fuel from the at least one measurement value.

The invention may preferably be employed in a stationary combustion engine, for marine applications or mobile applications, such as so-called “Non-Road-Mobile-Machinery” (NRMM)—preferably in each case in the form of a reciprocating piston engine. The combustion engine can serve as a mechanical drive, e.g. for operating compressor installations or in connection with a generator in a genset for production of electrical energy. The combustion engine preferably possesses a number of combustion chambers with corresponding gas feed devices and injectors. The control may occur individually for each combustion chamber.

Examples of embodiments of the invention are explained using the figures; these show

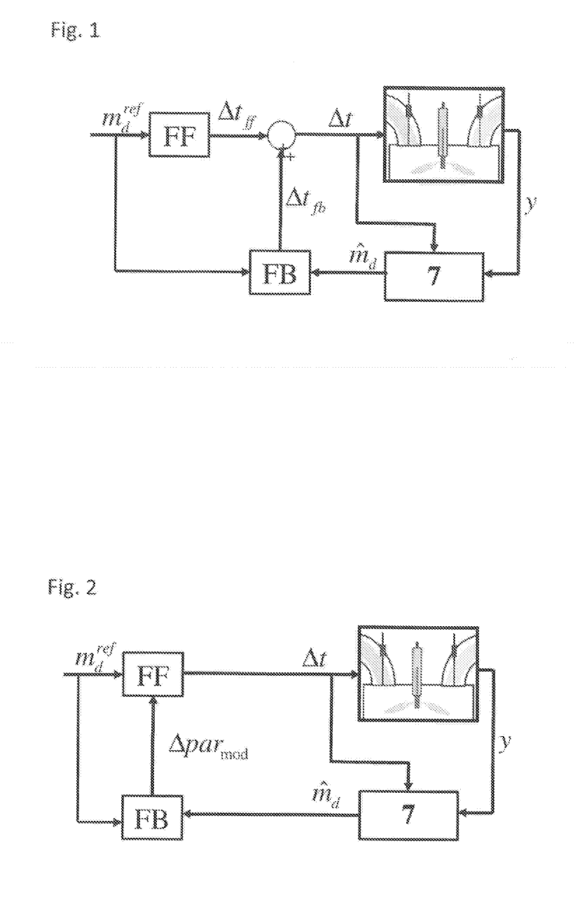

FIG. 1 a first embodiment of the control circuit in accordance with the invention

FIG. 2 a second embodiment of the control circuit in accordance with the invention

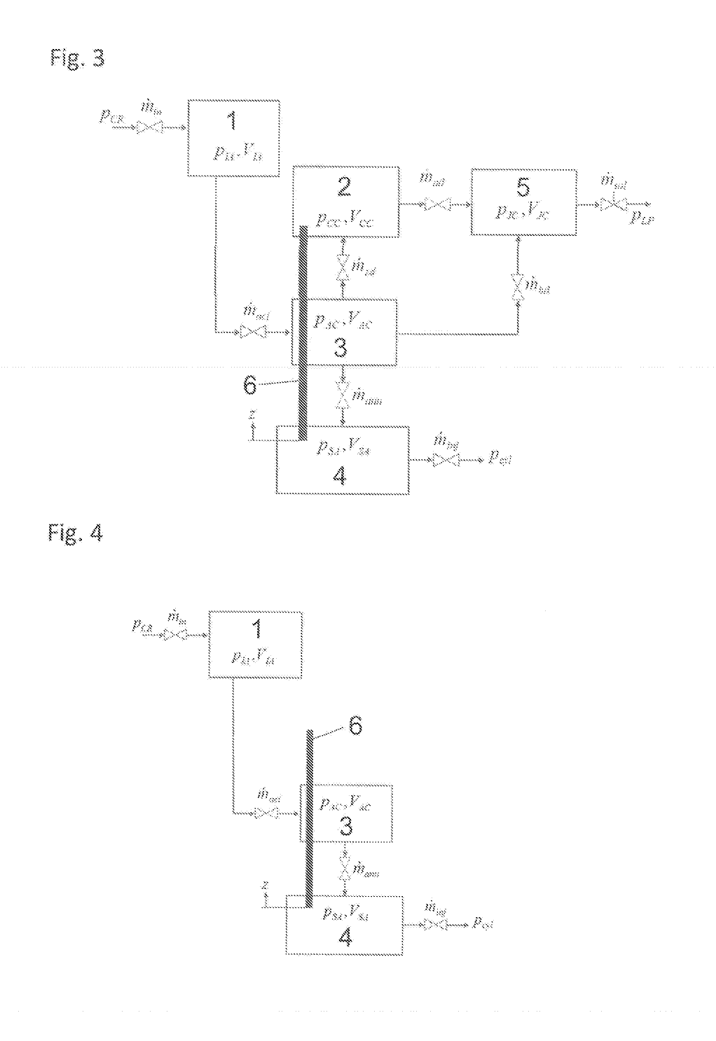

FIG. 3 a first example of schematic representation of an injector

FIG. 4 a second example of a schematic representation of an injector

It should be noted that none of the figures shows the gas feed device for feeding the gaseous fuel into the at least one combustion chamber, except for the schematically represented valves or the corresponding management or control system. These correspond to the state of the art.

FIG. 1:

The purpose of the injector control in this embodiment is the control of the actually injected mass of liquid fuel at a target value m_{d}^{ref}, by controlling the injection duration Δt. The regulation strategy is carried out by:
a preliminary control value (FF), which uses a required target value m_{d}^{ref} for the mass of liquid fuel to calculate a preliminary control signal Δ_{t ff} (also referred to below as “control command”) for the injection duration Δₜ and
a feedback loop (FB), which by using an observer system 7 (“State Estimator”) takes into account the control command for the injection duration Δₜ and at least one measurement value y (e.g. one of the pressure progressions Pia, Pcc, Pjc, Pac, Psa, occurring in the injector or the commencement of the lift-off of the needle from the needle seat (via the injector model) estimates by means of the injector model the mass flow md of liquid fuel introduced through the output opening of the injector and, where required, corrects the target value Δ_{tff} calculated by the preliminary control for the injection duration by using a correction value Δ_{tfb} (which may be negative) so that it becomes the actual duration of the actuator triggering signal Δt.

The preliminary control ensures a fast system response, since it triggers the injector with an injection duration Δt, as if no injector variability existed. The preliminary control uses a calibrated field of injector characteristics (which indicates the current supply duration via the injection mass or volume) or to convert the inverted injector model into the preliminary control command Δ_{tff} for the injection duration using the target value m_{d}^{ref} for the mass of liquid fuel.

The feedback loop (FB) is used in order to correct any inaccuracies in the preliminary control process (due to manufacturing variability, wear, etc.) which cause injector drift. The feedback loop compares the target value m_{d}^{ref} with the estimated injected mass md of liquid fuel and gives as a feedback a correcting control command Δtfb for the injection duration, if there is any discrepancy between m_{d}^{ref} and md. The addition of Δtff and Δtfb gives the definitive injection duration Δt.

The observer system estimates the injected mass md of liquid fuel depending on the at least one measurement value y and the final injection duration Δt. The at least one measurement value y can, for example, refer to: common rail pressure Pcr, pressure in the input accumulation chamber Pia, pressure in the control chamber Pcc or the commencement of the lift-off of the needle from the needle seat. The observer system uses a reduced injector model in order to estimate the injected mass md of liquid fuel.

FIG. 2:

This figure shows a control system constructed as a single unit (without preliminary control command Δ_{dff}) in which the actuator triggering signal Δₜ is calculated on the basis of the target value m_{d}^{ref} for the injected mass of liquid fuel and on the basis of the parameter Δ^{par}_{mod} used in the preliminary control model and estimated by the observer system. Hence an adaptive preliminary control signal is produced, which is modified by the observer system. Therefore in this case, the means of control is not constructed in two components with a preliminary control and a feedback loop that corrects the preliminary control signal.

FIG. 3 shows a block diagram for a reduced injector model. The injector model consists of a structural model for the injector and a system of equations for describing the dynamic behaviour of the

structural model. The structural model consists of five modelled volumes: Intake accumulator, accumulator chamber, control chamber, volume above the needle seat (“Small Accumulator Chamber”),and connection volume (“Junction”).

The intake accumulator chamber 1 represents the accumulation of all the volumes between the input choke and the non-return valve. The accumulator chamber 3 represents the combination of all volumes from the non-return valve to the volume above the needle seat. The volume above the needle seat represents a combination of all volumes between the needle seat up to the output opening of the injector. The connection volume 5 represents the combination of all the volumes which connect the volumes of the accumulator chamber 3 and the control chamber 2 with the solenoid valve.

FIG. 4 shows an injector with an alternative construction, capable of operating without a control chamber, for example, an injector in which the needle is triggered by means of a Piezo element.

The following system of equations does not refer to the version shown in FIG. 4. The formulation of a suitable system of equations may be produced analogously to the equation system shown below.

The dynamic behaviour of the structural model is described through the following equation system:

Pressure Dynamics

The development through time of the pressure within each of the volumes is calculated on the basis of a combination between the mass conservation equation and the pressure-density characteristic of the liquid fuel. The progression through time of the pressure is determined by:

$$\begin{matrix}{\dot{p}}_{IA} = \frac{{K}_{f}}{{p}_{IA} {V}_{IA}} ( {\dot{m}}_{in} - {\dot{m}}_{aci} ) & EQ . 1.1 \\ {\dot{p}}_{CC} = \frac{{K}_{f}}{{ρ}_{CC} {V}_{CC}} ( {\dot{m}}_{zd} - {\dot{m}}_{ad} - {ρ}_{CC} {\dot{V}}_{CC} ) & EQ . 1.2 \\ {\dot{p}}_{JC} = \frac{{K}_{f}}{{ρ}_{JC} {V}_{JC}} ( {\dot{m}}_{bd} - {\dot{m}}_{ad} - {\dot{m}}_{sol} ) & EQ . 1.3 \\ {\dot{p}}_{A C} = \frac{{K}_{f}}{{ρ}_{A C} {V}_{A C}} ( {\dot{m}}_{aci} - {\dot{m}}_{ann} - {\dot{m}}_{bd} - {\dot{m}}_{zd} - {ρ}_{A C} {\dot{V}}_{AC} ) & EQ . 1.4 \\ {\dot{p}}_{SA} = \frac{{K}_{f}}{{ρ}_{SA} {V}_{SA}} ( {\dot{m}}_{ann} - {\dot{m}}_{inj} - {ρ}_{SA} {\dot{V}}_{SA} ) & EQ . 1.5\end{matrix}$$

Symbols Used in the Formulae
P_{IA}: Pressure in the intake accumulator chamber 1 in bar
P_{CC}: Pressure in the control chamber 2 in bar
P_{JC}: Pressure in the junction volume 5 in bar
P_{AC}: Pressure in the accumulator chamber 3 in bar
P_{SA}: Pressure in the small accumulator chamber 4 in bar
P_{IA}: Diesel mass density within the intake accumulator chamber 1 in kg/m³
P_{CC}: Diesel mass density within the control chamber 2 in kg/m/³
P_{JC}: Diesel mass density within the junction volume 5 in kg/m³
P_{AC}: Diesel mass density within the accumulation chamber 1 in kg/m³
P_{SA}: Diesel mass density within the small accumulator chamber 4 in kg/³
K_{f}: Compression modulus of the Diesel fuel in bar

Needle Dynamics

The needle position is calculated by means of the following movement equation:

$$\begin{matrix}\ddot{Z} = \{ \begin{matrix}0 if {F}_{hyd} \leq {F}_{pre} \\ \frac{1}{m} ( {F}_{hyd} - Kz - B \hat{z} - {F}_{pre} ) if {F}_{hyd} > {F}_{pre}\end{matrix} & EQ . 2.1 \\ {F}_{hyd} = {p}_{A C} {A}_{A C} + {p}_{SA} {A}_{SA} - {p}_{CC} {A}_{CC} & EQ . 2.2 \\ 0 \leq z \leq {z}_{max} & EQ . 2.3\end{matrix}$$

Symbols used in the formulae:
z: Needle position in metres (m)
zₘₐₓ: Maximum displacement of the needle 6 in m
k: Stiffness of spring in N/m
B: Spring damping co-efficient in N·s/m
Fₚᵣₑ: Spring pretension in N
A_{ac}: Hydraulic effective area in the accumulator chamber 3 in m²
Aₛₐ: Hydraulic effective area in the small accumulator chamber 4 in m²
A_{cc}: Hydraulic effective area in the control chamber 2 in m²

Dynamics of the Solenoid Valve

The solenoid valve is modelled through a first-order transfer function, which converts the valve opening command into a valve position. This is provided by:

$${\to }^{{u}_{sol}^{cmd}} \frac{{z}_{sol}^{max}}{{τ}_{sol} s + 1} {\to }^{{z}_{sol}}$$

The transient system behaviour is characterised by the time constant tₛₒₗ

and the position of the needle 6 at maximum valve opening is given by Z^{max}/ₛₒₗ1

A piezo-electric operation is also possible instead of a solenoid valve.

Mass Flow Rates

The mass flow rate through each valve is calculated using the standard choked flow equation for liquids, which is:

$$\begin{matrix}\text{?} & EQ . 3.1 \\ & EQ . 3.2 \\ & EQ . 3.3 \\ & EQ . 3.4 \\ & EQ . 3.5 \\ & EQ . 3.6 \\ & EQ . 3.7 \\ & EQ . 3.8 \\ \\ \text{?} \text{indicates text missing or illegible when filed} & EQ . 3.9\end{matrix}$$

Formula symbols used:
mₙ: Mass flow density through the input choke in kg/s
m_{bd}: Mass flow rate via the bypass valve between accumulator chamber 3 and junction volume 5 in kg/s
m_{ad}: Mass flow rate via feeder valve at the entry point of the control chamber 2 in kg/s
m_{ad}: Mass flow rate via the discharge valve from control chamber 2 in kg/s
mₒₗₗ: Mass flow rate via the solenoid valve in kg/s
mₐₗₗ: Mass flow rate via the entry point into the accumulator chamber 3 in kg/s
mₐₙ: Mass flow rate via the needle seat in kg/s
mᵢₙ: Mass flow rate via the injector jet in kg/s

On the basis of the injector model formulated above, the professional will obtain the estimated value m_{d} by means of the observer system in a manner which is in principle already known (see e.g. B. Iserman, Rolf, “Digitale Regelsysteme” [“Digital control systems”], Springer Verlag Heidelberg 1977, Chapter 22.3.2, Page 379 et seq. or F. Castillo et al. “Simultaneous Air Fraction and Low-Pressure EGR Mass Flow Rate Estimation for Diesel Engines”, IFAC Joint conference SSSC-

5th Symposium on System Structure and Control, Grenoble, France 2013).

By using the above system of equations, it is possible to construct the so-called “observer equations”, preferably making use of an observer system which is known in principle, of the “sliding mode observer” type, by adding to the equations in the injector model the so-called “observer law”. For a “sliding mode” observer, one obtains the observer law by calculating a hypersurface using the at least one measurement signal and the value that results from the observer equations. By squaring the equation for the hypersurface, one obtains a generalised Lyapunov equation (generalised energy equation). This is a functional equation. The observer law represents that function which is minimised by the functional equation. This can be determined by variation techniques, which are known in principle, or numerically. This process is carried out within a combustion cycle for each step in time (depending on the time resolution of the control system).

Depending on the application, the result is the estimated injected mass of liquid fuel, the position of needle 6 or one of the pressures in one of the volumes of the injector.

What we claim is:

1. A Dual-fuel combustion engine, comprising:
a control device;
at least one combustion chamber;
at least one gas delivery device for delivering a gaseous fuel to at least one combustion chamber; and
at least one injector that can be regulated via the control device using an actuator triggering signal, for an injection of liquid fuel into the at least one combustion chamber; wherein the at least one injector comprises an output—opening for a liquid fuel closable by a needle; wherein the control device, via the actuator triggering signal, —controls opening of the needle in a ballistic region of the needle in a pilot operating mode of the combustion engine; and wherein an algorithm is stored in the control device, which receives as an input value at least the actuator triggering signal, and calculates a mass of liquid fuel transferred through the output opening of the at least one injector via an injector model, compares the mass calculated using the injector model with a required target value of the mass of liquid fuel, and either leaves it unchanged or corrects the actuator triggering signal, depending on a result of the comparison.

2. The combustion engine of claim 1, wherein the algorithm comprises a preliminary control, which calculates a preliminary control signal for the actuator triggering signal for an injection duration, based on the required target value of the mass of liquid fuel.

3. The combustion engine of claim 1, wherein at least one sensor is operable to measure at least one measurement value of the at least one injector, for which purpose the sensor is or can be brought into signal connection with the control device.

4. The combustion engine of claim 1, wherein the algorithm possesses a feedback loop which, after the actuator triggering signal is calculated by a preliminary control for injection duration and an at least one measurement value, calculates the mass of liquid fuel introduced through the output—opening of the at least one injector by means of the injector model and, if required, corrects by a correction factor the target value calculated by the preliminary control.

5. The combustion engine of claim 1, wherein the algorithm possesses an observer system, which estimates the mass of liquid fuel injected by using the injector model, the actuator triggering signal, and the at least one measurement value.

6. The combustion engine of claim 1, wherein the injector model comprises:
pressure progressions in volumes of the at least one injector filled with liquid fuel;
mass flow rates between the volumes of the at least one injector filled with liquid fuel;
a position of the needle in relation to a needle seat; and
dynamics of an actuator of the needle.

7. The combustion engine of claim 1, wherein the at least one injector comprises:
an intake accumulator chamber connected with a Common-Rail of the combustion engine;
the intake accumulator chamber for liquid fuel connected with the-accumulator chamber;
a volume above a needle seat connected with the accumulator chamber;
a junction-volume connected on one side with the accumulator chamber and on another side with an outflow duct;
the output opening for liquid fuel capable of being closed by means of the needle and connected with the volume above the needle seat;
the actuator triggered by an actuator triggering signal for opening the needle; and
a control chamber connected on one side with the accumulator chamber and on another side with a connection volume.

8. The combustion engine of claim 1, wherein the at least one measurement value is selected from the following values or a combination thereof:
pressure of one Common-Rail of the combustion engine;
pressure (PIA) in one input accumulator chamber of the injector;
pressure in one control chamber of the injector; and
commencement of lift-off of the needle from a needle seat.

9. The combustion engine of claim 1, wherein the control device carries out the algorithm during each combustion cycle, or during selected combustion cycles of the combustion engine and corrects the actuator triggering signal during such combustion cycle, if differences.

10. The combustion engine of claim 1, wherein the control device carries out the algorithm during each combustion cycle or during selected combustion cycles of the combustion engine, and if differences, carries out a correction of the actuator triggering signal for a subsequent combustion cycle.

11. The combustion engine of claim 1, wherein the control device carries out the algorithm during each combustion cycle or during selected combustion cycles of the combustion engine and statically evaluates any differences occurring, and carries out a correction of the actuator triggering signal for a current or for a subsequent combustion cycles based on the static evaluation.

12. A process for operating the Dual-fuel combustion engine of claim 1, wherein the liquid fuel, as a pilot fuel, and gaseous fuel are introduced into the combustion chamber of the combustion engine, with the mass of liquid fuel introduced into the combustion chamber calculated based on the actuator triggering signal of an actuator for the at least one injector of the liquid fuel using an injector model, and the actuator triggering signal corrected upon differences between a target value of the mass of the liquid fuel and the calculated mass.

13. A process for the operation of an injector, comprising: injecting a liquid fuel into a combustion chamber of a combustion engine; introducing a mass of liquid fuel into a combustion chamber by an injector; calculating the mass of liquid fuel introduced into the combustion chamber using an injector model for an actuator triggering signal of an actuator of the injector for the liquid fuel; and correcting the actuator triggering signal if differences between a target value for the mass of liquid fuel and the mass calculated.
